(19) United States
(12) Patent Application Publication
(10) Pub. No.: US 2006/0206700 A1
(43) Pub. Date: Sep. 14, 2006

(54) Information processing apparatus and activation controlling method

(76) Inventor: Hideyuki Umedu, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/368,058

(22) Filed: Mar. 3, 2006

(30) Foreign Application Priority Data
Mar. 11, 2005 (JP) 2005-069892

(51) Int. Cl. G06F 15/177

(52) U.S. Cl. 713/1

(57) ABSTRACT

According to one embodiment, an information processing apparatus includes a body, a storage device which stores an operating system, a first switch provided to the body, a second switch provided to the body, a power control unit which turns on a power supply of the body in response to one of operations of the first switch and the second switch, a determining unit which determines whether the first switch or the second switch is operated, and a controlling unit which boots the operating system after executing a first boot-up processing including processing for initializing a plurality of devices including the storage device, when the first switch is operated, and boots the operating system after executing a second boot-up processing in which a part of the processing of the first boot-up is skipped, when the second switch is operated.

### CROSS-REFERENCE TO RELATED APPLICATIONS

This application is based upon and claims the benefit of priority from Japanese Patent Application No. 2005-069892, filed Mar. 11, 2005, the entire contents of which are incorporated herein by reference.

### BACKGROUND

1. Field

One embodiment of the invention relates to an information processing apparatus such as a personal computer or the like, and an activation controlling method used in the apparatus.

2. Description of the Related Art

In recent years, various portable personal computers of laptop or notebook type have been developed. A computer of this type is used not only in the home or office but also in a mobile environment such as an outing destination.

In the home or office, the computer is required to have various functions. For example, the computer is often required to be activated (booted up) from another bootable device other than a hard disk drive. For this reason, upon power-on of the computer, initialization processing of almost all hardware components is executed. Hence, a relatively long period is required to activate the computer. On the other hand, in the mobile environment, the computer is required to speed up the boot-up processing rather than functions.

Jpn. Pat. Appln. KOKAI Publication No. 8-63252 (patent reference 1) discloses an information processing apparatus having a function of changing a startup mode in accordance with the user's operation of a keyboard. In this information processing apparatus, one of three modes, i.e., a diagnosis startup mode, normal startup mode, and high-speed startup mode is selected in accordance with a combination of keys pressed immediately after its power-on.

The information processing apparatus of patent reference 1 always perform key checking processing required to select the startup mode immediately after its power-on, and its activation time takes longer accordingly. The user is required to immediately make an operation for pressing keys in a predetermined combination after power-on of the information processing apparatus, resulting in a troublesome operation. Furthermore, the user is required to keep combinations of specific keys in mind.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the outer appearance of an information processing apparatus according to an embodiment of the present invention;

FIG. 2 is an exemplary block diagram showing an example of the system arrangement of the information processing apparatus shown in FIG. 1;

FIG. 3 is an exemplary flowchart for explaining the sequence of boot-up processing to be executed by the information processing apparatus shown in FIG. 1; and

FIG. 4 is an exemplary flowchart for explaining an example of the sequence of boot-up processing to be executed by the information processing apparatus shown in FIG. 1.

### DETAILED DESCRIPTION

Various embodiments according to the invention will be described hereinafter with reference to the accompanying drawings. In general, according to one embodiment of the invention, there is provided an information processing apparatus including a body, a storage device which stores an operating system, a first switch provided to the body, a second switch provided to the body, a power control unit which turns on a power supply of the body in response to one of operations of the first switch and the second switch, a determining unit which determines whether the first switch or the second switch is operated, and a controlling unit which boots the operating system after executing a first boot-up processing including processing for initializing a plurality of devices including the storage device, when the first switch is operated, and boots the operating system after executing a second boot-up processing in which a part of the processing of the first boot-up is skipped, when the second switch is operated.

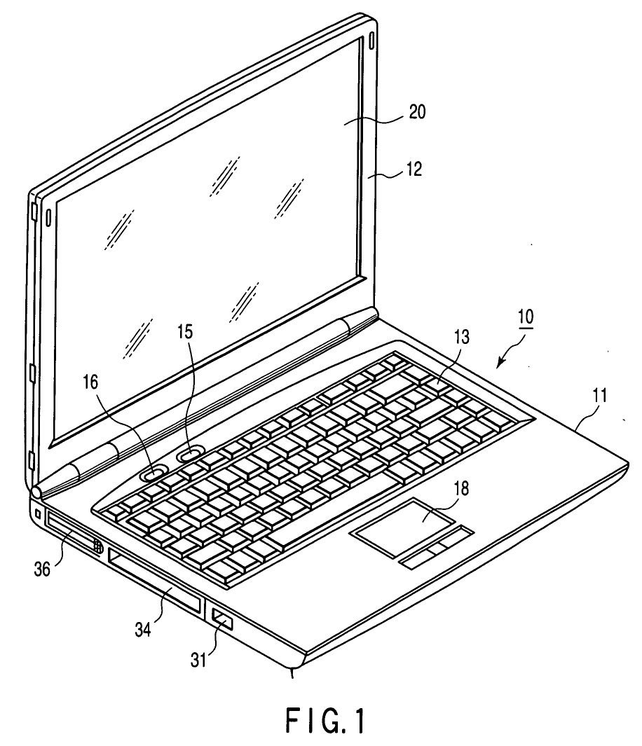

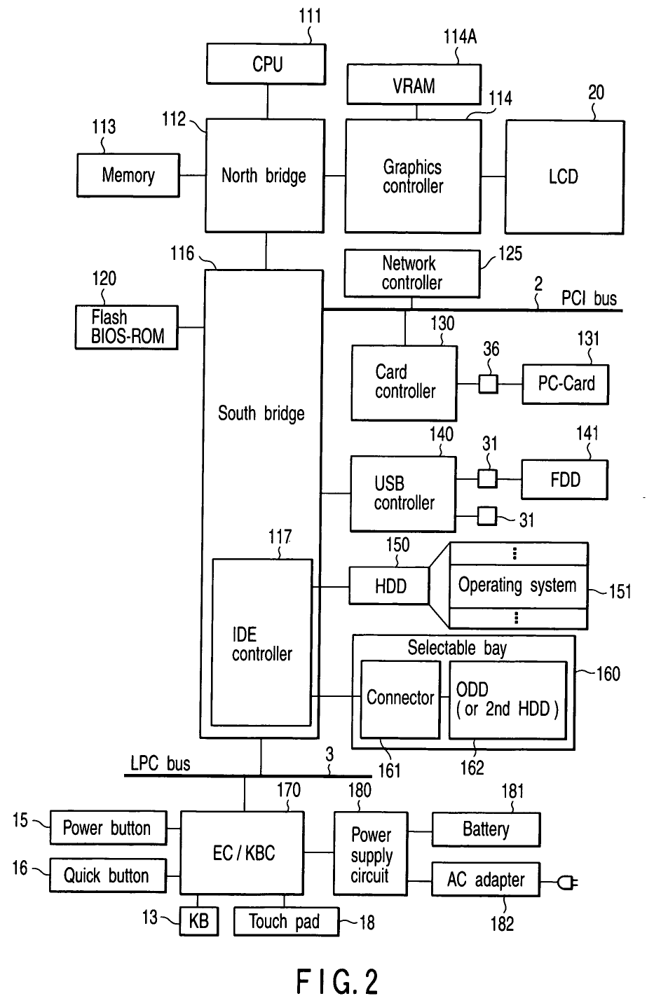

The arrangement of an information processing apparatus according to an embodiment of the present invention will be described below with reference to FIGS. 1 and 2. This information processing apparatus is a portable information processing apparatus which can be driven by a battery, and is implemented as a notebook-type personal computer 10.

FIG. 1 is a perspective view when a display unit of the notebook type personal computer 10 is opened. the computer 10 comprises a computer main body 11 and display unit 12. The display unit 12 is a display device main body which incorporates a display device comprising a liquid crystal display 20 (LCD). The display screen of the LCD 20 is located at nearly the center of the display unit 12.

The display unit 12 is supported on the computer main body 11, and rotatably attached between a closed position with the upper surface of the computer main body 11 is covered and a release position with respect to the computer main body 11. The computer main body 11 has a low-profile box-shaped housing. On the top surface of the computer main body 11, a keyboard 13, a power button switch 15 used to turn on/off the power supply of the computer 10, a quick button switch 16 used to activate the computer 10 at high speed, a touch pad 18, and the like are arranged.

On the side wall of the computer main body 11, a universal serial bus (USB) port 31, a selectable bay 34, a card slot 36, and the like are mounted. The USB port 31 is a connection port used to connect a USB compatible device. The selectable bay 34 is a drive bay used to selectively mount devices such as an optical disc drive (ODD), a hard disk drive (HDD), and the like to the computer main body 11. The card slot 36 is used to mount a card device such as a PC card or the like to the computer main body 11.

The computer 10 includes two switches, i.e., the power button switch 15 and quick button switch 16 as those for turning on the power supply of the computer 10. When the power supply of the computer 10 is turned on by the user's operating the power button switch 15, normally boot-up processing is executed. On the other hand, when the power supply of this computer 10 is turned on by the user's operating the quick button switch 16, high-speed boot-up processing for booting up the computer 10 at higher speed than the normally boot-up processing is executed.

The normally boot-up processing is processing for booting an operating system stored in the HDD after first boot-up processing including processing for initializing various devices provided to the computer 10 is executed. In the first boot-up processing, not only initialization of the HDD but also initialization processing of various other devices (e.g., the ODD, a flexible disc drive (FDD), the PC card, or the like) which are not required to boot the operating system from the HDD are executed. Furthermore, in the first boot-up processing, various kinds of key check processing are executed. For example, the presence or absence of a key input that instructs to display a basic input/output system (BIOS) setup window as a setup window required to set an operation environment of the computer 10, the presence or absence of a key input that designates a bootable device (the ODD, the FDD, or the like) other than the HDD as a boot device, and the like are checked.

The high-speed boot-up processing is processing for booting the operating system stored in the HDD after second boot-up processing in which some predetermined processes in the first boot-up processing are skipped is executed. In the second boot-up processing, execution of initialization processing of devices which are not required to boot the operating system from the HDD is skipped. More specifically, execution of the initialization processing of the ODD, the FDD, the PC card, and the like is skipped. Furthermore, in the second boot-up processing, the key check processing for checking the presence or absence of a key input that designates to display the BIOS setup window, and the key check processing for checking the presence or absence of a key input that designates a boot device are skipped. Hence, when the power supply of this computer 10 is turned on by operating the quick button switch 16, functions such as selection of a boot device, settings of the operation environment, and the like cannot be executed. However, the time required from when the power supply of the computer 10 is turned on until the operating system is booted can be greatly shortened.

The system arrangement of this computer 10 will be described below with reference to FIG. 2.

This computer 10 includes a CPU 111, a north bridge 112, a main memory 113, a graphics controller 114, a liquid crystal display (LCD) 20, a south bridge 116, a flash BIOS-ROM 120, a network controller 125, a card controller 130, a USB controller 140, a hard disc drive (HDD) 150, a selectable bay device 160, an embedded controller/keyboard controller IC (KC/KBC) 170, a power supply circuit 180, and the like.

The CPU 111 is a processor which controls the operations of respective components of this computer 10. This CPU 111 executes an operating system 151 and various application programs which are loaded from the HDD 150 onto the main memory 113. The CPU 111 also executes a system BIOS stored in the flash BIOS-ROM 120. The system BIOS is a program for hardware control. The system BIOS includes a routine for executing a power on self test (POST) processing, a routine for booting the operating system 151, and the like.

The north bridge 112 is a device bridge that connects a local bus of the CPU 111 and the south bridge 116. The north bridge 112 also has a function of executing a communication with the graphics controller 114 via an accelerated graphics port (AGP) bus or the like.

The graphics controller 114 is a display controller which controls the LCD 20 used as the display monitor of this computer 10. The graphics controller 114 displays data stored in a VRAM 114A on the LCD 20. The south bridge 116 incorporates an integrated drive electronics (IDE) controller 117 which controls the HDD 150, selectable bay device 160, and the like. The south bridge 116 is connected to a peripheral component interconnect (PCI) bus 2 and a low pin count (LPC) bus 3. The south bridge 116 is also connected to the USB controller 140.

The HDD 150 is a storage device which stores various kinds of software and data. The HDD 150 pre-stores the aforementioned operating system 151.

The selectable bay device 160 includes, e.g., a connector 161 and optical disc drive (ODD) 162. The ODD 162 is a drive unit for driving optical storage media such as a digital versatile disc (DVD), a compact disc (CD), and the like. In place of the ODD 162, a selectable bay device 160 which incorporates the second HDD in addition to the HDD 150 may be used.

The USB controller 140 controls a USB device connected to the USB port 31. To the USB port 31, for example, a flexible disc drive (FDD) 141 can be connected. Of course, the FDD 141 may be incorporated in the computer 10.

To the PCI bus 2, the network controller 125 and card controller 130 are connected. The network controller 125 is a communication device used to connect the computer 10 to a network. The card controller 130 controls a card device such as a PC card 131 or the like inserted into the card slot 36.

The embedded controller/keyboard controller IC (EC/KBC) 170 is a 1-chip microcomputer on which an embedded controller for power management and a keyboard controller that controls the keyboard (KB) 13, a touch pad 18, and the like are integrated. The embedded controller/keyboard controller IC (EC/KBC) 170 has a function of turning on the power supply of the computer 10 in response to the user's operation of the power button switch 15 or quick button switch 16 in collaboration of the power supply circuit 180. The power supply circuit 180 generates a system power supply to be supplied to respective components of this computer 10 using a battery 181 or an external power supply supplied via an AC adapter 182.

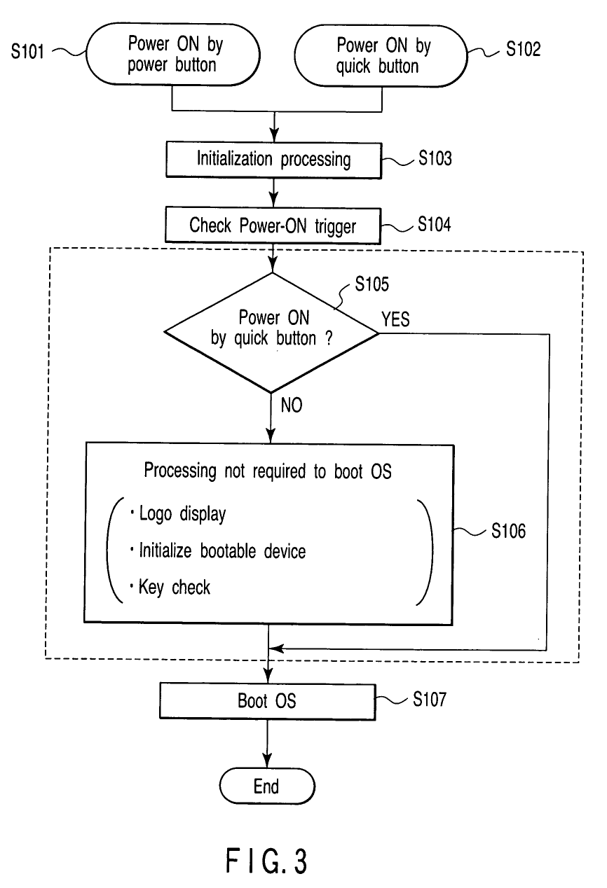

The sequence of the boot-up processing to be executed by the system BIOS will be described below with reference to the flowchart of FIG. 3. This boot-up processing is executed when the user operates either the power button switch 15 or quick button switch 16 provided to the computer 10.

As described above, when the user operates either the power button switch 15 or the quick button switch 16, as described above (step S101 or S102), the power supply of the computer 10 is turned on. After the power supply of this computer 10 is turned on, the CPU 111 executes the system BIOS first. The system BIOS initializes hardware components (the IDE controller 117, the HDD 150, and the like) required to boot the operating system from the HDD 150 (step S103). After that, the system BIOS determines, with reference to, e.g., the contents of a status register in the embedded controller/keyboard controller IC 170, whether or not the power-on trigger of the computer 10 corresponds to the operation of the power button switch 15 or the operation of the quick button switch 16 (step S104).

If the power-on trigger corresponds to the operation of the power button switch 15 (NO in step S105), the system BIOS executes initialization processing of various other devices (e.g., the ODD 162, the FDD 141, the PC card 131, and the like) which are not required to boot the operating system from the HDD 150 (step S106). In step S106, the system BIOS also executes processing for initializing the graphics controller 114, and displaying a predetermined logo image (an opening image) on the LCD 20. In step S106, the system BIOS further executes key check processing for determining the presence or absence of an input key that designates a bootable device other than the HDD 150 as a boot device and the like. After that the system BIOS executes processing for booting the operating system from the HDD 150 (step S107). If the user designates, e.g., the FDD 141 as a boot device by the key input, the system BIOS executes processing for booting the operating system from the FDD 141.

On the other hand, if the power-on trigger corresponds to the operation of the quick button switch 16 (YES in step S105), the system BIOS skips the processing in step S106, and executes the processing for booting the operating system from the HDD 150 (step S107). Since the operating system has a function of initializing the FDD 141, the USB device, the ODD 162, the PC card 131, and the like. If the processing in step S106 is skipped, these devices (the FDD 141, the USB device, the ODD 162, the PC card 131) can be used in the operation environment after the operating system is booted.

In addition, when the processing in step S106 is skipped, the system BIOS may notify the operating system of execution of the high-speed boot-up processing, and the presence of devices which initialization processing is not executed, and the like. After the computer 10 is booted, the operating system displays a message indicating that the computer 10 is booted by the high-speed boot-up processing on the LCD 20. This message can inform the user that the computer 10 is booted by the high-speed boot-up processing.

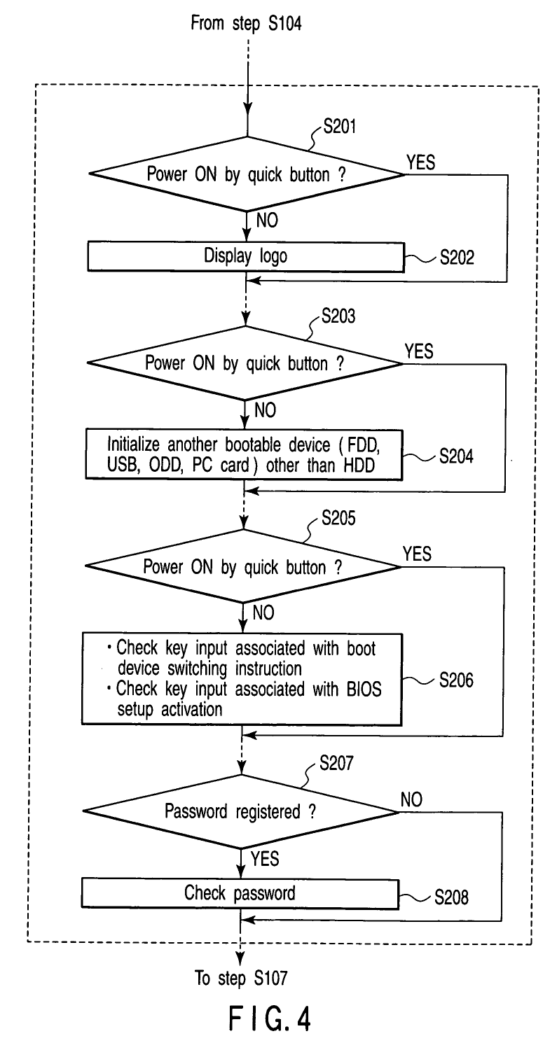

An example of practical processes which are skipped when the power-on trigger corresponds to the operation of the quick button switch 16 will be described below with reference to the flowchart of FIG. 4.

Steps S201 and S202 correspond to the processing sequence associated with logo display. If the power-on trigger corresponds to the operation of the power button switch 15 (NO in step S201), the system BIOS displays the logo image on the LCD 20 (step S202). On the other hand, if the power-on trigger corresponds to the operation of the quick button switch 16 (YES in step S201), the processing in step S202 is skipped.

Steps S203 and S204 correspond to the processing sequence associated with initialization of a bootable device. If the power-on trigger corresponds to the operation of the power button switch 15 (NO in step S203), the system BIOS executes initialization of other bootable devices (the FDD 141, the USB device, the ODD 162, the PC card 131, and the like) other than the HDD 150 to allow to boot the operating system from a device other than the HDD 150 (step S204). On the other hand, if the power-on trigger corresponds to the operation of the quick button switch 16 (YES in step S203), the processing in step S204 is skipped.

Steps S205 and S206 correspond to the processing sequence associated with key check processing. If the power-on trigger corresponds to the operation of the power button switch 15 (NO in step S205), the system BIOS executes key check processing of a key input associated with a switching instruction of a boot device and key check processing associated with the BIOS setup activation (step S206). If the key input associated with the switching instruction of a boot device is detected, the system BIOS selects a bootable device designated by that key input as a boot device used to boot the operating system. On the other hand, if the key input associated with the BIOS setup activation is detected, the system BIOS executes processing for displaying the BIOS setup window on the LCD 20. On the other hand, if the power-on trigger corresponds to the operation of the quick button switch 16 (YES in step S205), the processing in step S206 is skipped.

Steps S207 and S208 correspond to the processing sequence associated with password check processing. The system BIOS determines if a password is registered in the BIOS-ROM 120 (step S207). If the password is registered (YES in step S207), the system BIOS executes password check processing for checking if a password input by the user matches that stored in the BIOS-ROM 120 (step S208). If the password input by the user does not match that stored in the BIOS-ROM 120, execution of subsequent processes is inhibited.

In this manner, skip processes are provided at pivotal points of the boot-up processing sequence. In this way, when the power supply of the computer 10 is powered on operation of the quick button switch 16, functions such as selection of a boot device, settings of the operation environment, and the like cannot be executed. However, the time required from when the power supply of the computer 10 is powered on until the operating system 151 is booted can be greatly shortened.

The user can use the aforementioned high-speed boot-up processing by only pressing the quick button switch 16 without any special key operations. Also, since the normally boot-up processing is executed upon operation of the power button switch 15, the user can easily selectively use the high-speed boot-up processing and the normally boot-up processing depending on the location to use the computer 10, use purpose, and the like.

In this embodiment, the power button switch 15 and the quick button switch 16 are provided on the computer main body 11, but they may be provided on the display unit 12. In a normal use environment, the high-speed boot-up processing can be used as default boot-up processing, thus posing no problem. For this reason, the quick button switch 16 with a relatively large size may be provided on the top surface of the computer main body 11, and the power button switch with a size smaller than the quick button switch 16 may be provided on the side surface of the computer main body 11 or the like as an emergency button switch.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a body;
a storage device which stores an operating system;
a first switch provided to the body;
a second switch provided to the body;
a power control unit which turns on a power supply of the body in response to one of operations of the first switch and the second switch;
a determining unit which determines whether the first switch or the second switch is operated; and
a controlling unit which boots the operating system after executing a first boot-up processing including processing for initializing a plurality of devices including the storage device, when the first switch is operated, and boots the operating system after executing a second boot-up processing in which a part of the processing of the first boot-up is skipped, when the second switch is operated.

2. The apparatus according to claim 1, wherein the first boot-up processing includes processing for initializing another bootable device other than the storage device, and
the controlling unit includes a skipping unit which skips execution of the processing for initializing the another bootable device when the power-on trigger of the body corresponds to the operation of the second switch.

3. The apparatus according to claim 1, further comprising a display device, wherein:
the first boot-up processing includes processing for displaying a predetermined image on the display device, and
the controlling unit includes a skipping unit which skips execution of the processing for displaying the predetermined image when the second switch is operated.

4. The apparatus according to claim 1, wherein the first boot-up processing includes processing for checking presence/absence of a key input that designates to display a setting window used to set an operation environment of the information processing apparatus, and
the controlling unit includes a skipping unit which skips execution of the processing for checking the presence/absence of the key input when the second switch is operated.

5. The apparatus according to claim 1, wherein the first boot-up processing includes processing for checking presence/absence of a key input that designates another bootable device as a boot device, and
the controlling unit includes a skipping unit which skips execution of the processing for checking the presence/absence of the key input when the second switch is operated.

6. An activation controlling method of activating an information processing apparatus including a storage device that stores an operating system, the method comprising:
powering on a power supply of the information processing apparatus in response to one of operations of a first switch and a second switch provided to the information processing apparatus;
determining whether the first switch or the second switch is operated; and
booting the operating system after executing a first boot-up processing including processing for initializing a plurality of devices including the storage device, when the first switch is operated, and booting the operating system after executing a second boot-up processing in which a part of the processing of the first boot-up is skipped, when the second switch is operated.

7. The method according to claim 6, wherein the first boot-up processing includes processing for initializing another bootable device other than the storage device, and
the booting includes skipping execution of the processing for initializing the another bootable device when the second switch is operated.

8. The method according to claim 6, wherein the first boot-up processing includes processing for displaying a predetermined image on a display device provided to the information processing apparatus, and the booting includes skipping execution of the processing for displaying the image when the second switch is operated.

9. The method according to claim 6, wherein the first boot-up processing includes processing for checking presence/absence of a key input that designates to display a setting window used to set an operation environment of the information processing apparatus, and
the booting includes skipping execution of the processing for checking the presence/absence of the key input when the second switch is operated.

10. The method according to claim 6, wherein the first boot-up processing includes processing for checking presence/absence of a key input that designates another bootable device as a boot device, and
the booting includes skipping execution of the processing for checking the presence/absence of the key input when the second switch is operated.
